(19) United States
(12) Patent Application Publication
(10) Pub. No.: US 2025/0307912 A1
(43) Pub. Date: Oct. 2, 2025

(54) PLATFORM FOR UTILIZATION OF NON-FUNGIBLE TOKENS FOR DIGITAL BUILDING INFORMATION

(71) Applicant: INTEGRATED PROJECTS TECHNOLOGY INC., New York, NY (US)

(72) Inventor: Jose CRUZ, Jr., New York, NY (US)

(21) Appl. No.: 18/864,844

(22) PCT Filed: May 9, 2023
(86) PCT No.: PCT/US2023/021490

§ 371 Date: Nov. 11, 2024

Related U.S. Application Data
(60) Provisional application No. 63/339,816, filed on May 9, 2022.

(51) Int. Cl. G06Q 30/0645; G06F 30/13; G06Q 50/163

(52) U.S. Cl. CPC G06Q 30/0645; G06F 30/13; G06Q 50/163; G06Q 2220/00

(57) ABSTRACT

Example methods disclosed herein include creating a primary non-fungible token (NFT), the primary NFT representing digital assets associated with a physical building, creating a plurality of level NFTs from the digital assets associated with the physical building, wherein each of the level NFTs represents digital assets associated with a sub-portion of the physical building, and providing use of a level NFT of the plurality of level NFTs to a tenant in conjunction with lease of the sub-portion of the physical building represented by the level NFT.

### CROSS-REFERENCE TO RELATED APPLICATIONS

This application claims the benefit of priority to U.S. Provisional Application No. 63/339,816, entitled “PLATFORM FOR UTILIZATION OF NON-FUNGIBLE TOKENS FOR DIGITAL BUILDING INFORMATION,” and filed on May 9, 2022, which is incorporated by reference herein in its entirety.

### FIELD

This application relates generally to the use of non-fungible tokens (NFTs) for management of digital assets related to physical buildings.

### BACKGROUND

The process of digitization of physical buildings creates useful digital assets reflecting the actual conditions of a building. Such assets may be useful in renovation of buildings, redesigns, configuring virtual tours for sale or rental of buildings, and the like. Such assets may also be useful for placing buildings within the metaverse. However, the process of digitization is often expensive, and digital assets may be lost over time. For example, such assets are often distributed to contractors, tenants, and other parties and are, accordingly, not centrally located or readily available to building owners. Building owners may further elect not to digitize buildings due to difficulties in recovering costs associated with digitization and difficulties maintaining ownership of digital assets resulting from digitization.

### SUMMARY

Example methods disclosed herein include creating a primary non-fungible token (NFT), the primary NFT representing digital assets associated with a physical building, creating a plurality of level NFTs from the digital assets associated with the physical building, wherein each of the level NFTs represents digital assets associated with a sub-portion of the physical building, and providing use of a level NFT of the plurality of level NFTs to a tenant in conjunction with lease of the sub-portion of the physical building represented by the level NFT.

In some examples, providing use of the level NFT includes providing access to the digital assets associated with the sub-portion of the physical building represented by the level NFT for a period of time of a lease of the sub-portion of the physical building by the tenant.

In some examples, creating the primary NFT includes utilizing an NFT marketplace to record the primary NFT on a blockchain and conferring ownership of the primary NFT to an owner of the physical building.

In some examples, creating the plurality of level NFTs includes dividing the digital assets associated with the physical building into a plurality of level digital assets, wherein each of the plurality of level digital assets are associated with a respective sub-portion of the physical building.

In some examples, creating the plurality of level NFTs includes utilizing an NFT marketplace to record each of the plurality of level NFTs on a blockchain and conferring ownership of each of the plurality of level NFTs to an owner of the building.

In some examples, providing use of the level NFT of the plurality of level NFTs to the tenant includes maintaining, by an owner of the building, ownership of the level NFT.

In some examples, the digital assets associated with the physical building include one or more of a building information model (BIM) of the physical building, a digital twin of the physical building, an engineering report of the physical building, and verified dimensions of the physical building.

In some examples, the method further includes viewing the digital assets associated with the physical building at a user portal associated with an owner of the physical building.

In some examples, the method further includes viewing digital assets associated with the sub-portion of the physical building at a user portal associated with the tenant.

Example methods disclosed herein include receiving, from a user, a request to access a user portal, where the user portal displays one or more digital assets representing one or more respective physical properties, determining the one or more respective physical properties associated with the user, retrieving the one or more digital assets representing the one or more respective physical properties, and displaying, at the user portal, the one or more digital assets representing the one or more respective physical properties.

In some examples, displaying, at the user portal, the one or more digital assets

corresponding to the one or more physical properties includes displaying digital assets associated with a plurality of physical buildings owned by the user.

In some examples, displaying, at a user portal, the one or more digital assets corresponding to the one or more physical properties includes displaying digital assets associated with a plurality of sub-portions of physical buildings leased by the user.

In some examples, the one or more digital assets include one or more of building information models (BIMs) of the one or more physical properties, digital twins of the one or more physical properties, engineering reports for the one or more physical properties, and verified dimensions of the one or more physical properties.

Example non-transitory computer readable media are disclosed herein. The non-transitory computer readable media are encoded with instructions which, when executed by one or more processors of a platform coordination system, cause the platform coordination system to create a primary non-fungible token (NFT), wherein the primary NFT represents digital assets associated with the physical building and to create a plurality of level NFTs from the digital assets associated with the physical building, where each of the level NFTs represent digital assets associated with a sub-portion of the physical building. The instructions further cause the platform coordination system to provide use of a level NFT of the plurality of level NFTs to a tenant in conjunction with lease of the sub-portion of the physical building represented by the level NFT.

In some examples, the instructions further cause the platform coordination system to provide use of the level NFT by providing access to the digital assets associated with the sub-portion of the physical building represented by the level NFT for a period of time of a lease of the sub-portion of the physical building by the tenant.

In some examples, the instructions further cause the platform coordination system to create the primary NFT by utilizing an NFT marketplace to record the primary NFT on a blockchain and conferring ownership of the primary NFT to an owner of the physical building.

In some examples, the instructions further cause the platform coordination system to create a plurality of level NFTs by dividing the digital assets associated with the physical building into a plurality of level digital assets, wherein each of the plurality of level digital assets are associated with a respective sub-portion of the physical building.

In some examples, the instructions further cause the platform coordination system to create the plurality of level NFTs by utilizing an NFT marketplace to record each of the plurality of level NFTs on a blockchain and conferring ownership of each of the plurality of level NFTs to an owner of the building.

In some examples, the digital assets associated with the physical building include one or more of a building information model (BIM) of the physical building, a digital twin of the physical building, an engineering report for the physical building, and verified dimensions of the physical building.

In some examples, the instructions further cause the platform coordination system to provide a first user portal associated with the owner of the physical building, where the first user portal allows the owner of the physical building to view the digital assets associated with the physical building and to provide a second user portal associated with the tenant, where the second user portal allows the tenant to view the digital assets associated with the sub-portion of the physical building.

Additional embodiments and features are set forth in part in the description that follows, and will become apparent to those skilled in the art upon examination of the specification and may be learned by the practice of the disclosed subject matter. A further understanding of the nature and advantages of the present disclosure may be realized by reference to the remaining portions of the specification and the drawings, which form a part of this disclosure. One of skill in the art will understand that each of the various aspects and features of the disclosure may advantageously be used separately in some instances, or in combination with other aspects and features of the disclosure in other instances.

### BRIEF DESCRIPTION OF THE DRAWINGS

The description will be more fully understood with reference to the following figures in which components are not drawn to scale, which are presented as various examples of the present disclosure and should not be construed as a complete recitation of the scope of the disclosure, characterized in that:

FIG. 1 illustrates an example platform coordination system and various systems in communication with the platform coordination system through a network, in accordance with various embodiments of the disclosure.

FIG. 2 illustrates an example platform coordination system accessible through a user portal in accordance with various embodiments of the disclosure.

FIG. 3 illustrates an example platform coordination system in communication with an owner portal and a tenant portal in accordance with various embodiments of the disclosure.

FIG. 4 illustrates an example user interface configured by a platform coordination system in accordance with various embodiments of the disclosure.

FIG. 5 is a schematic diagram of an example computer system implementing various embodiments in the examples described herein.

FIG. 6 illustrates an example process for configuration of a user interface by a platform coordination system in accordance with various embodiments of the disclosure.

FIG. 7 illustrates an example process for providing use of a portion of a non-fungible token (NFT) in accordance with various embodiments of the disclosure.

### DETAILED DESCRIPTION

Owners and tenants of buildings, including commercial office buildings, often utilize information about the buildings in marketing, renovating, and otherwise planning for use of a building or a portion of a building. However, assets related to buildings, such as floor plans, electrical plans, and the like, often do not reflect the realities of a building's current condition or use. Accordingly, the use of digital assets to quantify the actual state of a building, such as building information models (BIMs) is useful in planning, renovation, design, and the like.

Creation of digital assets for commercial buildings may be time and cost intensive, and owners may have little control over such assets after creation. For example, collection of registered point cloud data of a building, aggregation of such point cloud data into a BIM, and generation of additional digital assets (such as dimensions, engineering reports, and the like), may be a resource intensive process. Often, such digital assets may be stored in various unsecured folders controlled by various consultants (e.g., architects, contractors, engineers, and the like), such that it may be difficult for a building owner to aggregate the digital assets and/or to transfer the digital assets to a new owner as part of, for example, the sale of a building. Accordingly, the process of digitization of a building may be repeated by new owners and/or new owners may not be able to utilize already created digital assets associated with the building.

Non-fungible tokens (NFTs) are units of data, stored on a blockchain, and associated with some form of digital content. When an NFT representing a digital asset is minted, the NFT is stored on a blockchain and acts as a way to verify underlying ownership of the digital asset. The NFT is associated with an address in the blockchain and authentication information, which allows ownership of the NFT to be authenticated by accessing the address in the blockchain. Creation of an NFT of digital assets associated with a building may allow a building owner to utilize the digital assets and, ultimately, obtain value from the digital assets by providing the assets to tenants, selling assets with the sale of the building, using digital twins to place the building in the metaverse, and the like. Further, the NFT provides for verification of ownership of the digital assets and simplifies the process of transfer of the assets to new owners of a building, reducing the need for new owners to repeat the process of digitizing the building.

Use of a single NFT to represent a whole building may be inefficient for allowing tenants to use digital assets representing a sub-portion of the building actually leased by the tenant. For example, a building owner may not wish to convey all digital assets representing a building to each tenant of the building due to file size and having many copies of the digital assets distributed to a large number of people and/or entities. Further, tenants may be less likely to utilize such digital assets due to higher storage requirements and difficulties in separating out information relevant to the area of the building actually leased by the tenant. Further, landlords or building owners may not wish to provide actual digital assets to tenants, who may not return the assets at the termination of the lease and/or may edit or otherwise change the digital assets over the term of the lease.

The platform coordination system described herein may allow building owners to control and utilize digital assets associated with various buildings by providing portals in communication with various services allowing owners to interact with digital assets through, for example, three dimensional tours, viewing dimensions and other building data, and the like. The portal may create a central location for a user to view digital assets associated with various buildings and/or properties associated with the user. The portal may further allow tenants to view and utilize digital assets related to portions of the building leased by the tenants. In some examples, tenants may be able to view and utilize digital assets in a variety of different building, leased from different owners.

The platform coordination system described herein may further allow building owners to create NFTs of the digital assets associated with a building, as well as facilitate the rental of, or otherwise providing use of, level NFTs associated with portions of a building to tenants or other users. For example, a building owner may rent out a level NFT associated with a floor of a building to a tenant renting the floor of the building for the lease term. The building owner may lease or provide level NFTs to other users for other purposes, such as advertisement of space for rent in the building. The creation of building NFTs and lease of level NFTs may allow building owners to derive value from digital assets, making owners more likely to utilize such digital assets. Further, the creation of level NFTs allows tenants access to only the portion of the digital assets that are actually useful to the tenant, without the transmittal of numerous files to the tenant. As the owner may retain the actual NFT of the level NFTs, the tenant may access the digital assets without the owner transferring the assets to the tenants, allowing the owner to reclaim the assets at the end of a lease term and offer the assets to new tenants for use.

Accordingly, the platform coordination system may increase use of such digital assets, ultimately resulting in more efficient construction, renovation, and design of spaces, as the digital assets may reflect the actual condition of the building. Owners may provide access to the digital assets to tenants while retaining ownership of the digital assets, reducing the likelihood of having to repeat the resource intensive process of creating the digital assets. Further, the platform coordination system reduces the need for tenants to store digital assets in their own storage, reducing the likelihood that assets are lost and decreasing storage needs for tenants. The centralized nature of the platform coordination system also allows both owners and tenants to interactively view various properties and access all of their associated digital assets in one location, without having to manage storage and dissemination of the assets.

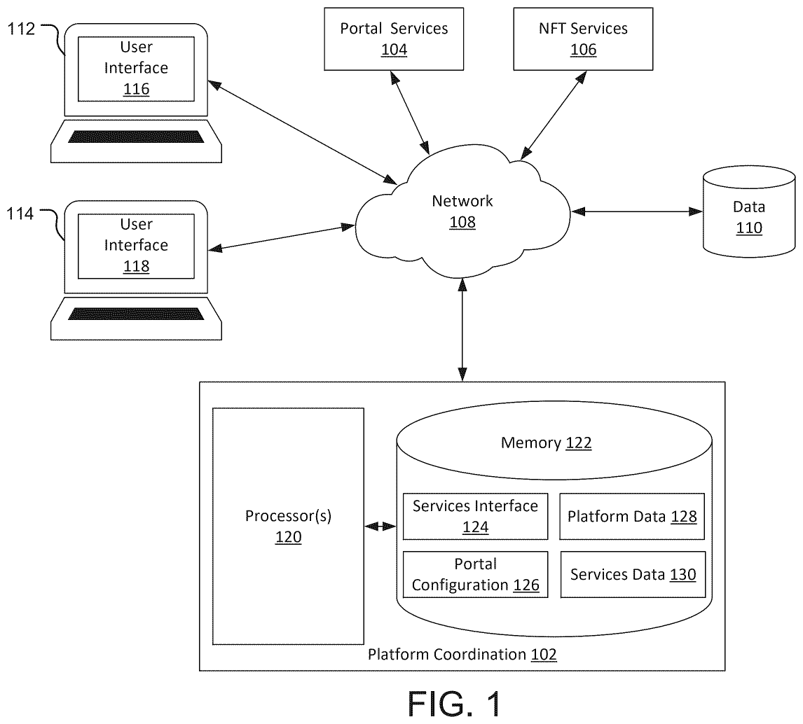

Turning now to the drawings, FIG. 1 illustrates an example platform coordination system 102. The platform coordination system 102 as disclosed herein may coordinate between multiple services and data sources to manage digital assets corresponding to buildings. The platform coordination system 102 may further coordinate between such services and data sources to allow building owners, tenants, and/or other parties (e.g., architects, contractors, designers, and the like) to access, interact with, and/or otherwise utilize the digital assets. In various examples, the platform coordination system 102 may further coordinate the creation of NFTs of building digital assets and/or may facilitate providing use of such NFTs or portions of such NFTs. In various examples, providing use of NFTs may include renting, leasing, providing temporary use in return for rent, but in some embodiments, transfer or conveyance of the NFTs. For example, the platform coordination system 102 may facilitate creation of a primary NFT including a building information model (BIM) of a building, along with other digital assets associated with the building. The platform coordination system 102 may facilitate ownership of the primary NFT by an owner of the building and rental of portions of the primary NFT (e.g., related to floors, suites, or other portions of the building) to other parties, such as tenants of the building.

As described herein, the platform coordination system 102 may generally communicate with various services, such as BIM services 104 and NFT services and various data sources, such as data 110 to configure portals to a platform at user devices. Such portals may allow users to view and/or interact with digital assets associated with physical buildings. As used herein, a digital asset may be associated with a physical building or portion of a physical building when the digital asset represents the physical building and/or is created from data collected from the physical building. For example, a BIM generated using registered point cloud data collected from a LiDAR scan of a building interior is a digital asset associated with the building. Other forms of data about the building, such as square footage data generated from the BIM, may also be digital assets associated with the building. In some examples, digital assets may further include plans, architectural drawings, engineering drawings, and/or other schematics created using scan data and/or using existing plans of the building.

The platform coordination system 102 may be generally implemented by a computing device or combinations of computing resources in various embodiments. In various examples, the platform coordination system 102 may be implemented by one or more servers, cloud computing resources, and/or other computing devices. The platform coordination system 102 may, for example, utilize various processing resources to communicate with various services, access data, configure user portals, create and/or utilize building digital assets, and the like. The platform coordination system 102 may further include memory and/or storage locations to store program instructions for execution by the processor and various data utilized by the platform coordination system.

Platform services 104 and NFT services 106 may similarly be implemented by one or more computing devices or combinations of computing resources in various embodiments. Platform services 104 may include various services to create, interact with, and/or utilize BIM data for a building and other digital assets associated with the building. Examples of platform services 104 may include, in various examples, services for collecting and/or utilizing spatial data of a building to create BIM data and other digital assets for a building, services for configuring virtual tours of buildings using the digital assets (e.g., BIM data), services for displaying and/or providing additional data relevant to a building (e.g., market data), and/or other services facilitating connection and use of the platform management system 102, such as authentication services, payment services, and the like.

NFT services 106 may include various services to create (e.g., mint) a primary NFT and level NFTs, manage NFT ownership (e.g., by an NFT marketplace), facilitate rental of level NFTs, and the like. Such services may communicate with various entities, including the platform coordination system 102 and/or user devices 112 and 114, using the network 108. In various examples, NFT services 106 may also include digital wallets storing NFTs and/or digital assets represented by the NFTs, decentralized file systems storing digital assets represented by NFTs, and the like.

The network 108 may be implemented using one or more of various systems and protocols for communications between computing devices. In various embodiments, the network 108 or various portions of the network 108 may be implemented using the Internet, a local area network (LAN), a wide area network (LAN), a wide area network (WAN), and/or other networks. In addition to traditional data networking protocols, in some embodiments, data may be communicated according to protocols and/or standards including near field communication (NFC), Bluetooth, cellular connections, and the like.

Generally, the user devices 112 and 114 may be devices belonging to an end user, such as a building owner, building tenant, contractor, architect, or other entities or users accessing the platform coordination system 102. In some implementations, many user devices may be provided with access to the platform coordination system 102 and may access the platform coordination system 102 to view and/or utilize digital assets, including BIM data, relating to various buildings and/or portions of buildings. In some examples, user devices may access the platform coordination system 102 to utilize digital assets related to several different buildings, buildings owned by different owners, and the like.

In various implementations, the user device 112, the user device 114 and/or additional user devices may be implemented using any number of computing devices including, but not limited to, a computer, a laptop, tablet, mobile phone, smart phone, wearable device (e.g., AR/VR headset, smart watch, smart glasses, or the like), smart speaker, vehicle (e.g., automobile), or appliance. Generally, the user devices may include one or more processors, such as a central processing unit (CPU) and/or graphics processing unit (GPU). The user devices may generally perform operations by executing executable instructions (e.g., software) using the processor(s).

In various implementations, the platform coordination system 102 may include or utilize one or more hosts or combinations of compute resources, which may be located, for example, at one or more servers, cloud computing platforms, computing clusters, and the like. Generally, the platform coordination system 102 is implemented by compute resources including hardware for memory 122 and one or more processors 120. For example, the platform coordination system 102 may utilize or include one or more processors, such as a CPU, GPU, and/or programmable or configurable logic. In some embodiments, various components of the platform coordination system 102 may be distributed across various computing resources, such that the components of the platform coordination system 102 communicate with one another through the network 108 or using other communications protocols. For example, in some embodiments, the platform coordination system 102 may be implemented as a serverless service, where computing resources for various components of the platform coordination system 102 may be located across various computing environments (e.g., cloud platforms) and may be reallocated dynamically and/or automatically according to, for example, resource usage of the platform coordination system 102. In various implementations, the platform coordination system 102 may be implemented using organizational processing constructs such as functions implemented by worker elements allocated with compute resources, containers, virtual machines, and the like.

The memory 122 may include instructions for various functions of the platform coordination system 102 which, when executed by processor 120, perform various functions of the platform coordination system 102. The memory 122 may further store data and/or instructions for retrieving data used by the platform coordination system 102. Similar to the processor 120, memory resources utilized by the platform coordination system 102 may be distributed across various physical computing devices. In some examples, memory 122 may access instructions and/or data from other devices or locations, and such instructions and/or data may be read into memory 122 to implement the platform coordination system 102.

In various embodiments, memory 122 may store platform data 128. Platform data 128 may include, in various examples, data associated with various users (e.g., owners, tenants, contractors, and the like) of the platform coordination system 102. For example, platform data 128 may include user authentication information, user identifier, properties and/or buildings associated with a user (e.g., owned by the user, leased by the user, or the subject of a project user is contracted to complete), location of NFT wallets associated with the user, and the like. Platform data 128 may further, in various examples, include identifiers and/or access instructions for digital assets associated with various buildings and/or properties created in the platform coordination system 102. For digital assets not represented by NFTs, such identifiers may include the location of the digital assets (e.g., at data 110) and various instructions for accessing the data, such as predetermined queries to communicate with various databases. For digital assets represented by NFTs, such identifiers may further include wallets holding the NFTs representing the digital assets. Platform data 128 may further include various data used to generate user platforms, such as portal templates and the like.

In various embodiments, memory 122 may store services data 130. Services data 130 may include, for example, the structure of queries and/or calls to specific services in communication with the platform coordination system 102. Services data 130 may further include data regarding which services are in communication with the platform coordination system 102, which services are utilized for various requests received through user portals (e.g., through user interfaces 116 and 118), login credentials for the services, and the like. In some examples, some users may have access to some services while other users do not have such access. For example, owners of a building may be able to access market data relevant to the building while tenants may not. Owners of a building may further be able to access some NFT services (e.g., for creation of NFTs from digital assets or connection to an owner's digital wallet) that tenants may not be able to access. In some examples, some services may be available to some users who, for example, pay a premium for such additional services. Different users may further have access to different functionality dependent on the user's role and/or selected level of service. In these examples, services data 130 may include information about which users are able to access such services.

The memory 122 may include instructions implementing portal configuration 126 when executed by the processor 120. In various examples, portal configuration 126 may configure user portals for owners, tenants, and/or other parties (e.g., contractors) to view and/or utilize digital assets of a building or property. For example, when a user accesses the platform coordination system 102, portal configuration 126 may access platform data 128 to determine which buildings or properties within the system are associated with the user. Portal configuration 126 may further access portal data 128 and/or data 110 to locate and retrieve such digital assets for viewing through a portal, which may generally be presented at a user interface 116 of a user device 112 and/or at a user interface 118 of a user device 114. In various examples, portal configuration 126 may further receive input from a user through the portal (e.g., via a user interface 116 or 118) and may take various actions based on such input. For example, portal configuration 126 may receive user requests to perform actions using various services in communication with the platform coordination system 102. In such examples, portal configuration 126 may communicate with the services interface 124 to communicate with relevant services to fulfill the request. Portal configuration 126 may receive other input through user portals and may communicate with various other components of the platform coordination system 102 and/or services to store or utilize such input. For example, an owner minting an NFT of a building using one or more NFT services 106 may input wallet information. Portal configuration 126 may transmit the wallet information to an NFT marketplace of the NFT services 106 to facilitate transfer of the minted NFT to the owner's wallet.

In various embodiments, the memory 122 may include instructions implementing a services interface 124 when executed by the processor 120. The services interface 124 may communicate with portal services 104 and/or NFT services 106 to allow users to utilize various digital assets through user portals presented using the user interfaces 116 and/or 118. In some examples, a user may, through the user interface 116 or 118, request to utilize and/or view data from a portal service 104 and/or an NFT service 106. For example, a user may request to view a virtual tour of a building using BIM data associated with the building.

As described herein, the user interfaces 116 and 118 may provide connection to the platform coordination system 102 and may provide a centralized location for users to access and/or utilize all digital assets associated with buildings and/or portions of buildings owned or leased by the user. For example, building owners may view BIM data, floor plans, engineering reports, and the like for all buildings owned by the owner using a portal (e.g., a portal configured using portal configuration 126). The platform coordination system 102 (e.g., the services interface 124) may further communicate with portal services 104 to allow the owner to, using a user interface 116 or 118, create BIM data for a building based on spatial data for a building, configure virtual tours of buildings with existing BIM data, view various statistics for a building, and/or view additional information relevant to a building, such as market data (e.g., average rental pricing, occupancy data, and the like) for an area where the building is located. The platform coordination system 102 (e.g., the services interface 126) may further communicate with NFT services 106 to allow the owner to create and/or manage building NFTs representing the digital assets of a building and/or level NFTs representing the digital assets for a floor or other subdivision of a building. Such management of NFTs may include rental of level NFTs to tenants for a term of a lease. Such a user interface configured for an owner may, in various examples, be referred to as an owner portal.

In various examples, the user interfaces 116 and 118 may provide tenants with BIM data, floor plans, engineering reports, and the like for portions of buildings leased by the tenant. The tenant may, in some examples, be a company or organization with multiple office locations. In such examples, the user interfaces 116 and 118 may be configured for the company or organization to view digital assets related to all office spaces leased by the company or organization. Tenants may utilize such information to facilitate design of office space, to configure office layouts, to facilitate virtual tours of office space, and the like. In various examples, such digital assets may be represented by level NFTs owned by an owner of the building and rented to the tenant for a term of a lease of the building.

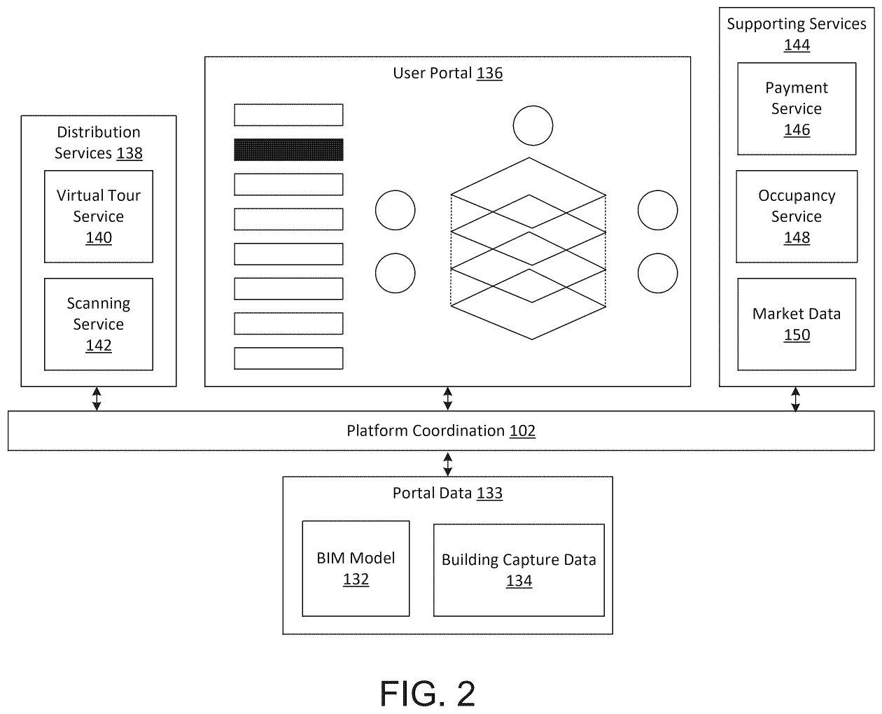

Turning to FIG. 2, the platform coordination system 102 may be accessible through a user portal 136. The platform coordination system 102 (e.g., portal configuration 126) may, as shown in FIG. 2, access portal data 133, communicate with distribution services 138 and communicate with supporting services 144 to configure a user interface of the user portal 136. For example, a user portal 136 may be associated with a particular user and may be utilized by that user to view and/or interact with digital assets associated with buildings owned and/or leased by the user. In some examples, such digital assets may include NFTs of a building and/or portions of a building. For example, where a user is a landlord, building owner, or property management company the user portal 136 may display digital assets associated with the buildings.

In various examples, users may, via interaction with the user interface of the user portal 136, request various functions of the distribution services 138 and/or the supporting services 144. In such examples, portal configuration 126 may receive such requests and communicate the requests to the services interface 124 to utilize the various services in communication with the platform coordination system 102. For example, users may utilize various distribution services 138 to create and/or utilize digital assets associated with a building or portion of a building. In various examples, the distribution services 138 may include a virtual tour service 140 and/or a scanning service 142. A virtual tour service 140 may utilize existing digital assets (e.g., BIM data) associated with a building to create virtual tours (e.g., for prospective buyers or tenants). Such virtual tours may be, for example, videos viewable using a mobile or other computing device. In some examples, such virtual tours may be configured to user interaction through an AR/VR device. A scanning service 142 may, in various examples, be used to import registered point cloud data collected from a building to the platform coordination system 102 for generation of digital assets associated with the building.

Various supporting services 144 in communication with the platform coordination system 102 may provide other functionality to the platform coordination system 102. For example, a payment service 146 in communication with the platform coordination system 102 may allow users to pay subscription fees, fees for accessing premium services from the platform coordination system 102, and the like. Occupancy services 148 and/or market data services 150 may be utilized by users to obtain more information about a building represented by digital assets through the user portal 136. For example, a market data service 150 may be accessible by a building owner in order to view pricing, occupancy data, and/or other information for a market including a building owned by the owner.

The platform coordination system 102 may further access portal data 133 to configure the user portal. Such portal data 133 may, in various examples, be stored at one or more databases 110 accessible by the platform coordination system 102 via the network 108. In various examples, the location of portal data 133 may be stored with platform data 128 accessed by portal configuration 126 when a user accesses the platform coordination system 102. In various examples, portal data may include building capture data 134 and/or existing digital assets 132 associated with a building or portion of a building.

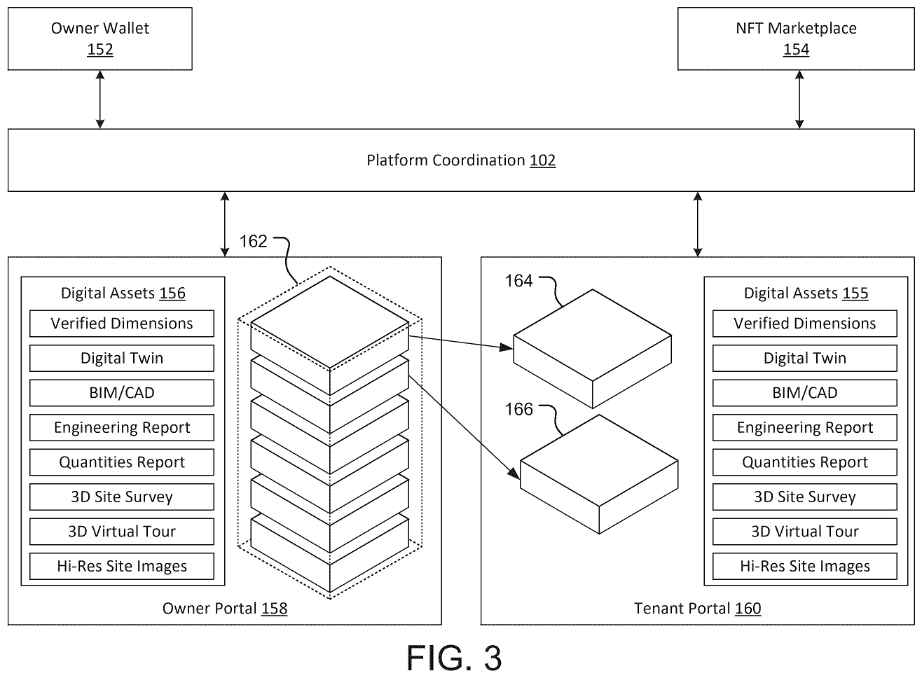

As shown in FIG. 3, the platform coordination system 102 may configure both an owner portal 158 and a tenant portal 160 to, for example, facilitate rental of digital assets associated with a building. The platform coordination system 102 may communicate with various NFT services 106, including owner wallet 152 and/or an NFT marketplace 154 to create a primary NFT 162 of the digital assets of a building.

The owner portal 158 may give the owner of a building access to the primary NFT 162 of the building. For example, the primary NFT may be associated with digital assets 156 related to all levels of a building, including, for example, verified dimensions of the building, a digital twin, BIM and/or CAD models, an engineering report, quantities report, 3 dimensional site survey, a three dimensional virtual tour, and high resolution site images. In various examples, the platform coordination system 102 may create the primary NFT 162 using the digital assets 156 related to the building. For example, the primary NFT 162 may be minted using the NFT marketplace 154 by recording the NFT on a blockchain (e.g., the Etherium blockchain) and offering the primary NFT 162 for sale to the owner through the NFT marketplace 154. The owner may purchase the primary NFT 162 and the digital assets 156 and/or access information for the digital assets 156 may be stored at the owner wallet 152. For example, the digital assets 156 represented by the primary NFT 162 may be stored in a decentralized file system and may be accessible by following a uniform resource identifier (URI) stored at the owner wallet 152 to locate the digital assets 156 in the decentralized file system.

Accordingly, to configure the owner portal 158, the platform coordination system 102 (e.g., portal configuration 126) may access platform data 128 for the owner, which may include wallet information connecting the platform coordination system 102 to the owner wallet 152. The platform coordination system 102 may then access the primary NFT 162 and/or the digital assets 156 using the owner wallet 152. In some examples, the primary NFT 162 and/or the digital assets 156 may be stored at the owner wallet 152. In some examples, the platform coordination system 102 may access the digital assets 156 and/or the primary NFT 162 using information in the owner wallet 152, such as a URI pointing to a location in a decentralized file system. In various examples, the owner portal 158 may be configured to allow for viewing of the digital assets 156 associated with the primary NFT 162. For example, a user accessing the owner portal 158 may view a 3D virtual tour of the building by selecting an option for viewing the 3D tour from a menu or icon displayed in the owner portal 158. In some examples, the owner portal 158 may also be configurable to view multiple primary NFTs and their associated digital assets. For example, an owner may own NFTs associated with multiple buildings. The owner may, through the owner portal 158, select one of the multiple buildings to view the digital assets associated with the selected building.

A tenant portal 160 may be used to access a view level NFTs 164 and 166 for portions of a building leased by the tenant. For example, a level NFT may represent an entire floor of a building, a suite of a building, or other subdivision of the building that is leased by a tenant. In various examples, the level NFTs 164 and 166 may be created using the digital assets associated with the primary NFT 162. For example, the digital assets associated with the primary NFT 162 may include floor plans, BIM data, and high resolution photos of each floor of a building. To create the level NFTs 164 and 166, the platform coordination system 102 may divide the building digital assets into level digital assets, where the level digital assets include all assets relating to a level (e.g., floor) of the building as a whole. The level NFTs 164 and 166 (and level NFTs for any other levels in the building) may then be minted and offered for sale at the NFT marketplace 154. When purchased by the owner, the level NFTs 164 and 166 may be stored at the owner wallet 152 along with the primary NFT 162.

To configure the tenant portal 160, the platform coordination system 102 (e.g., portal configuration 126) may access platform data 128 including data regarding levels of buildings associated with the tenant (e.g., levels of buildings for which the tenant has entered into a leasing agreement with the owner). Portal configuration 126 may then determine, also using platform data 128, the owners associated with the buildings and owning the level NFTs. Portal configuration 126 may locate the digital assets associated with the level NFTs 164 and 166 using the owner wallet 152 of the owners associated with the buildings. Similar to the owner portal 158, a user of the tenant portal 160 may, for the term of a lease, be able to access and utilize various digital assets 155 associated with the level NFTs 164 and 166. For example, the user may view and utilize BIM data, engineering reports, 3D virtual tours, and/or other digital assets associated with the level NFTs 164 and 166 for design, space planning, and other various uses.

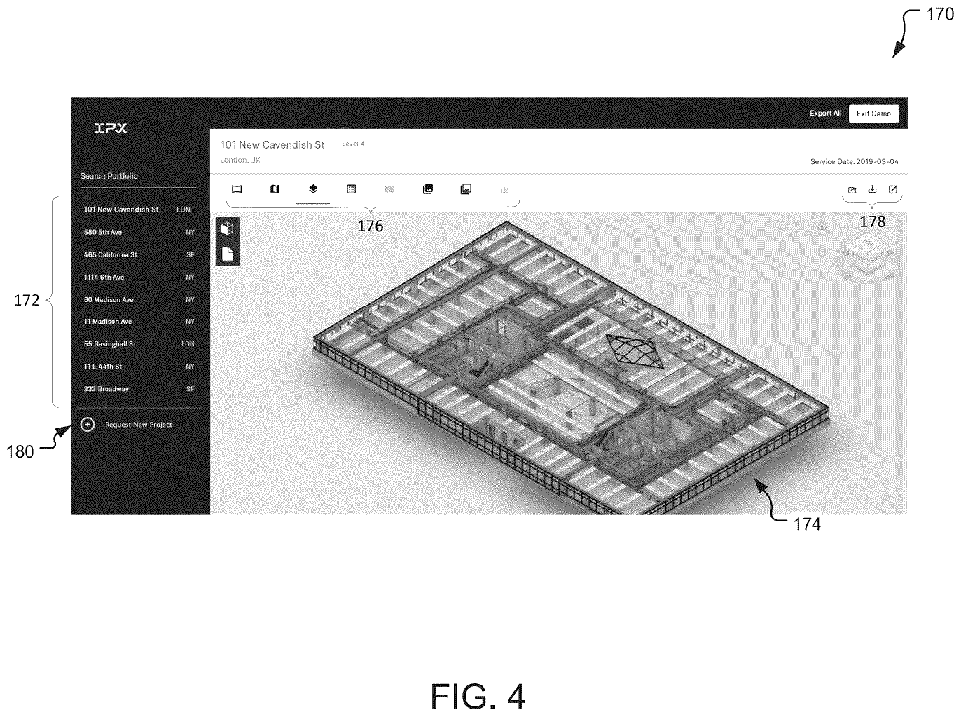

FIG. 4 shows an example user interface 170 configured by the platform coordination system 102. The user interface 170 may be displayed, in various examples, at user devices 112 and/or 114, using user interfaces 116 and/or 118. The user interface 170 may further be referred to herein as a user portal, owner portal, and/or tenant portal, in various contexts. The user interface 170 is generally configured for viewing digital assets related to buildings and/or portions of buildings associated with a user accessing the user interface 170 through the platform coordination system 102. For example, the user interface 170 may be associated with a tenant (e.g., a company or organization) leasing space at each of the buildings included in a portfolio. In some examples, the user interface 170 may be associated with a building owner, landlord, property management company, or other entity managing the spaces and/or buildings included in the portfolio of the user interface 170.

In various examples, the user interface 170 may be configured by platform configuration 126 of the platform coordination system 102. For example, the platform configuration system 126 may populate addresses of buildings and/or spaces included in a portfolio 172 using platform data 128 associating the user with such buildings and/or spaces. The platform configuration system 126 may further configure display of digital assets (e.g., digital asset 174) associated with a building responsive to a user selecting the address of the building from the portfolio 172 of the user interface 170. The platform configuration system 126 may further locate different types of digital assets responsive to a user selecting one of icons 176 representing the different types of digital assets. For example, the icons 176 may include icons which, when selected, allow a user to view BIM data, building statistics, engineering reports, 3D walkthroughs of the space, and the like.

In various examples, the user interface 170 may provide additional functionality beyond viewing and/or interacting with digital assets within the user interface 170. For example, the user interface 176 may include elements 178 which, when selected, allow a user to share, download, or otherwise utilize one or more digital assets outside of the user interface 170. For example, a user may select one of the elements 178 to share a virtual tour of a space with a real estate agent listing the space, or to share electrical and HVAC plans of the space with a contractor doing renovations of the space. The user interface 170 may further include an element 180 selectable to create additional digital assets for a new building location. In some examples, selection of the element 180 may cause display of an additional user interface allowing the user to order a scan of a space or building, to import registered point cloud data to create new digital assets, to import existing digital assets into the platform coordination system 102, and/or to perform other functions to add an additional building or portion of a building to the platform coordination system 102.

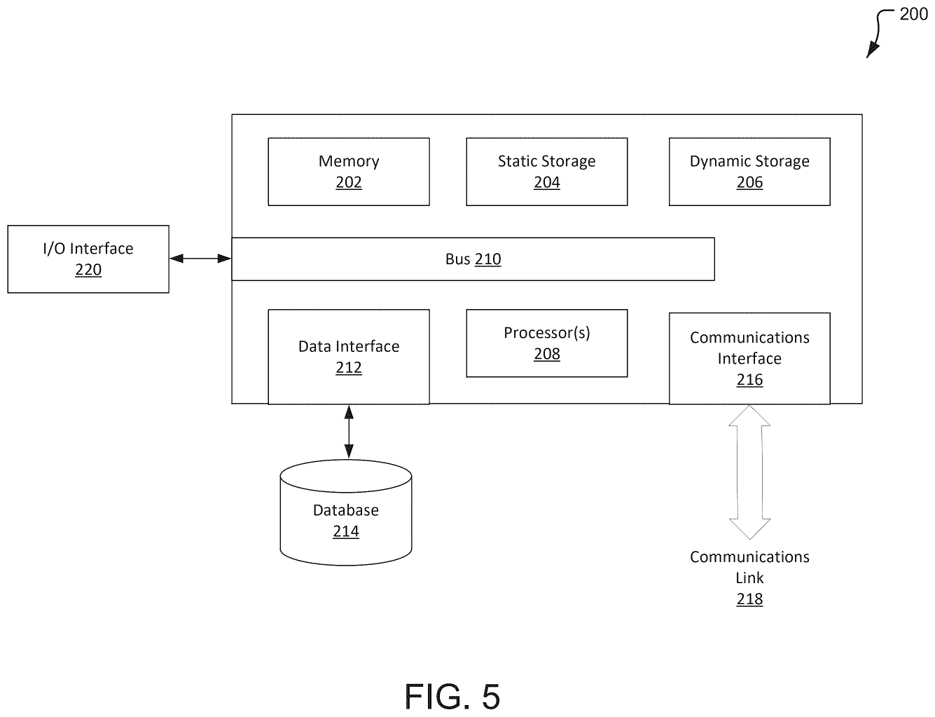

The platform coordination system 102 may be implemented using various computing systems. Turning to FIG. 5, an example computing system 200 may be used for implementing various embodiments in the examples described herein. For example, processor 120 and memory 122 may be located at one or several computing systems 200. In various embodiments, user device 116 is also implemented by a computing system 200. Various services, such as BIM services 104, NFT services 106, distribution services 138, and/or supporting services 144 may be implemented by one or more computing systems 200. This disclosure contemplates any suitable number of computing systems 200. For example, the a computing system 200 may be a server, a desktop computing system, a mainframe, a mesh of computing systems, a laptop or notebook computing system, a tablet computing system, an embedded computer system, a system-on-chip, a single-board computing system, or a combination of two or more of these. Where appropriate, the computing system 200 may include one or more computing systems; be unitary or distributed; span multiple locations; span multiple locations; span multiple machines; span multiple data centers; or reside in a cloud, which may include one or more cloud components in one or more networks.

Computing system 200 includes a bus 210 (e.g., an address bus and a data bus) or other communication mechanism for communicating information, which interconnects subsystems and devices, such as processor 208, memory 202 (e.g., RAM), static storage 204 (e.g., ROM), dynamic storage 206 (e.g., magnetic or optical), communications interface 216 (e.g., modem, Ethernet card, a network interface controller (NIC) or network adapter for communicating with an Ethernet or other wire-based network, a wireless NIC (WNIC) or wireless adapter for communicating with a wireless network, such as a WI-FI network), input/output (I/O) interface 220 (e.g., keyboard, keypad, mouse, microphone). In particular embodiments, the computing system 200 may include one or more of any such components.

In particular embodiments, processor 208 includes hardware for executing instructions, such as those making up a computer program. The processor 208 circuity includes circuitry for performing various processing functions, such as executing specific software for perform specific calculations or tasks. In particular embodiments, I/O interface 220 includes hardware, software, or both, providing one or more interfaces for communication between computing system 200 and one or more I/O devices. Computing system 200 may include one or more of these I/O devices, where appropriate. One or more of these I/O devices may enable communication between a person and computing system 200.

In particular embodiments, communications interface 216 includes hardware, software, or both providing one or more interfaces for communication (such as, for example, packet-based communication) between computing system 200 and one or more other computer systems or one or more networks. One or more memory buses (which may each include an address bus and a data bus) may couple processor 208 to memory 202. Bus 210 may include one or more memory buses, as described below. In particular embodiments, one or more memory management units (MMUs) reside between processor 208 and memory 202 and facilitate accesses to memory 202 requested by processor 208. In particular embodiments, bus 210 includes hardware, software, or both coupling components of computing system 200 to each other.

According to particular embodiments, computing system 200 performs specific operations by processor 208 executing one or more sequences of one or more instructions contained in memory 202. For example, instructions for the services interface 124 and portal configuration 126 may be contained in memory 202 and may be executed by the processor 208. Such instructions may be read into memory 202 from another computer readable/usable medium, such as static storage 204 or dynamic storage 206. In alternative embodiments, hard-wired circuitry may be used in place of or in combination with software instructions. Thus, particular embodiments are not limited to any specific combination of hardware circuitry and/or software. In various embodiments, the term “logic” means any combination of software or hardware that is used to implement all or part of particular embodiments disclosed herein.

The term “computer readable medium” or “computer usable medium” as used herein refers to any medium that participates in providing instructions to processor 208 for execution. Such a medium may take many forms, including but not limited to, nonvolatile media and volatile media. Non-volatile media includes, for example, optical or magnetic disks, such as static storage 204 or dynamic storage 206. Volatile media includes dynamic memory, such as memory 202.

Computing system 200 may transmit and receive messages, data, and instructions, including program, e.g., application code, through communications link 218 and communications interface 216. Received program code may be executed by processor 208 as it is received, and/or stored in static storage 204 or dynamic storage 206, or other storage for later execution. A database 214 may be used to store data accessible by the computing system 200 by way of data interface 212. For example, platform data 128 and services data 130 may each be stored using a database 214. In various examples, communications link 218 may communicate with, for example, user devices to display user interfaces to the platform coordination system 102.

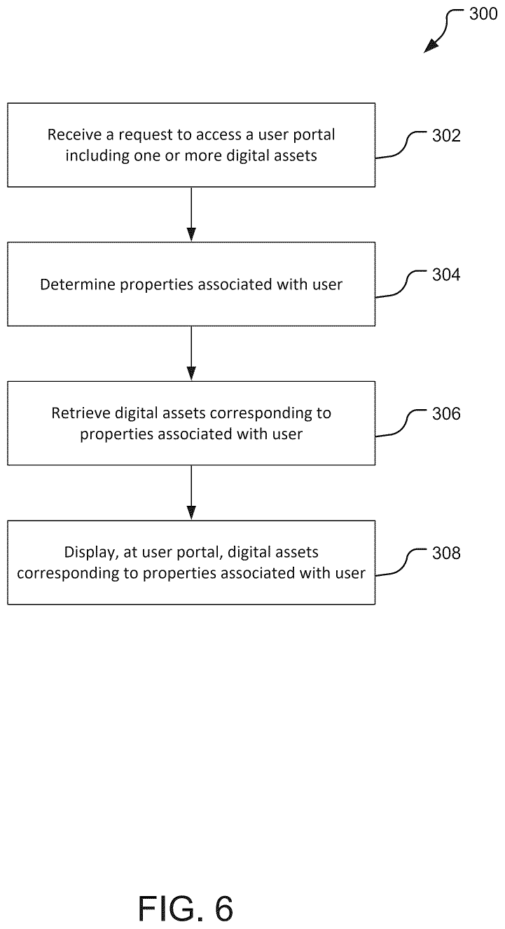

FIG. 6 illustrates an example process 300 for configuration of a user interface by a platform coordination system 102. The platform coordination system 102 receives a request to access a user portal including one or more digital assets at block 302. The platform coordination system 102 may receive such a request via portal configuration 126, in various examples. In various examples, the user portal may be an owner portal 158, a tenant portal 160, or other user portal 136 in communication with the platform coordination system 102. The user portal may be, in various examples, presented via a user interface 116 or a user interface 118 of a user device 112 or 114 associated with the user.

In various examples, the request may be a request to log into the platform coordination system 102. Such a request may be accompanied by additional information, such as a user identifier and/or password or other credentials used to access the platform coordination system 102. Portal configuration 126 may, in some examples, provide such passwords or user credentials to an authentication service in communication with the platform communication system 102 (e.g., via the network 108) to authenticate the user and provide access to the platform coordination system 102.

At block 304, the platform coordination system 102 (e.g., portal configuration 126) determines properties associated with the user. In various examples, portal configuration 126 may utilize a user identifier received with the request at block 302 to access information about properties associated with the user. For example, portal configuration 126 may access a data structure (e.g., a database) stored with platform data 128 to identify properties associated with the user based on the user identifier. In various examples, properties associated with a user may include buildings owned by an owner, floors of buildings leased by a tenant, buildings managed by a property management company, buildings or portions of buildings for which contractors are contracted to complete work (e.g., design or remodeling), and the like.

The platform coordination system 102 (e.g., portal configuration 126) retrieves digital assets corresponding to properties associated with the user at block 306. In some examples, portal configuration 126 may retrieve digital assets for a property responsive to the user selecting the property from a portfolio 172 presented in a user interface 170 of the user portal 136. In some examples, portal configuration 126 may retrieve all digital assets corresponding to properties associated with the user at the time the user logs into the platform coordination system 102 and the user interface 170 is rendered. In various examples, portal configuration 126 may access platform data 128 to determine the location of the various digital assets. In some examples, the digital assets may be stored with portal data 133 at a location accessible by the platform coordination system 102. For example, where the digital assets are not associated with an NFT representing the assets, the digital assets may be stored with portal data 133 at a location (e.g., database 110) accessible by the platform coordination system 102 via the network 108.

In various examples, the platform data 128 may indicate that the digital assets are represented by an NFT held by the owner. In such examples, the services interface 124 may access an NFT service 106 (e.g., the owner wallet 152) to access NFTs representing the digital assets. Such NFTs may be primary NFTs and/or level NFTs, depending on the property type. For example, where the property is an entire building, the services interface 124 may access the NFT service 106 to locate and retrieve digital assets both for the building as a whole and for individual floors of the building. In some examples, where an owner requests digital assets for a building, the services interface 124 may access NFT services 106 to locate and/or retrieve the primary NFT as well as any level NFTs that are not leased to tenants of the building. In various examples, the digital assets may be stored at an owner wallet 152, and the services interface 124 may retrieve the digital assets from the owner wallet 152. In other examples, the owner wallet 152 may store metadata providing a URI for accessing the digital assets. In such examples, the services interface 124 may access the metadata at the owner wallet 152 and retrieve the digital assets using the URI located at the owner wallet 152.

At block 308, the platform coordination system 102 displays, at a user portal, digital assets corresponding to properties associated with the user. In various examples, different digital assets may be displayed based on preferences of the user and/or selections made by the user within the user interface 170 of the user portal 136. For example, a user may select an icon of the icons 176 to view floor plans, and portal configuration 126 may render the floor plans at the user interface 170. Upon selection of a different icon of the icons 176, portal configuration may render a different digital asset associated with a selected property.

In some examples, the digital assets may be displayed with additional input from a portal service 104 in communication with the platform coordination system 102. For example, the service interface 124 may connect with a virtual tour service 140 to render a 3D virtual tour of a building using BIM data of the digital assets associated with the building.

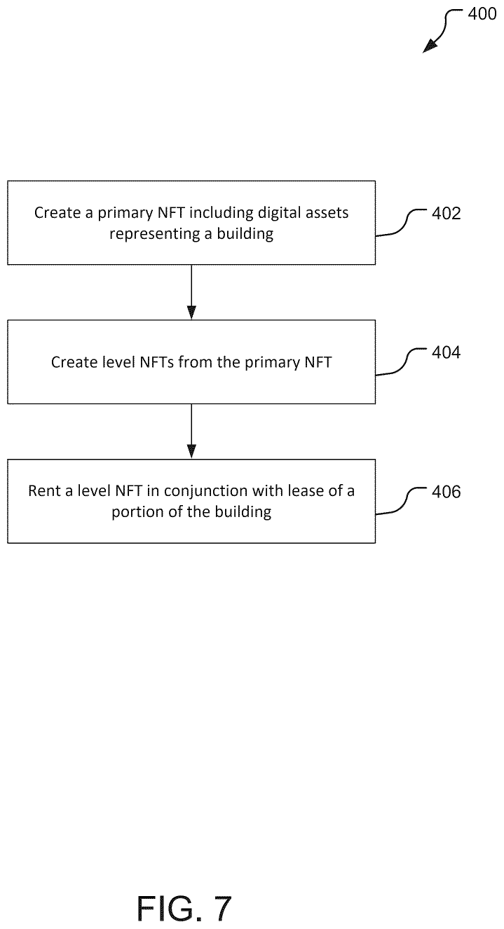

FIG. 7 illustrates an example process 400 for rental of a portion of an NFT. The platform coordination system 102 creates a primary NFT including digital assets representing a building at block 402. In various examples, the platform coordination system 102 may utilize an NFT marketplace 154 to mint the primary NFT 162, and the primary NFT 162 may be stored primarily at an owner wallet 152 associated with the owner. Generally, to mint the primary NFT, the services interface 124 may connect to the NFT marketplace 154. The services interface 124 may then request creation of the primary NFT 162 by, for example, providing additional metadata to be associated with the primary NFT 162 and linking the owner wallet 152 and/or another wallet associated with the platform coordination system 102 to pay any additional fees associated with the minting of the primary NFT 162, such as gas fees. In some examples, the services interface 124 may coordinate with portal configuration 126 to present an additional user interface to gather additional information from the owner for creation of the primary NFT 162 such as identification of digital assets to be represented by the primary NFT 162, additional metadata to be stored on the blockchain upon minting of the primary NFT 162, identifying information of the owner and/or the owner wallet 152, and the like.

In various examples, when the primary NFT 162 is minted at the NFT marketplace 154, the primary NFT 162 may be offered for sale through the NFT marketplace 154 exclusively to the owner using the owner wallet 152. When the owner purchases the primary NFT 162 through the NFT marketplace 154, the owner may receive for storage, at the owner wallet 152, certificate information indicating ownership of the primary NFT 162, metadata to access the digital assets represented by the primary NFT 162, the blockchain address of the primary NFT 162, and/or additional information regarding the primary NFT 162.

At block 404, the platform coordination system 102 creates level NFTs from the primary NFT. In various examples, the platform coordination system 102 may access the digital assets 156 represented by the primary NFT 162 to generate the level NFTs. The platform coordination system 102 may separate out portions of the digital assets 156 by floor or other subdivision (e.g., suites) based on data stored with the digital assets 156. For example, the digital assets 156 may include floorplans for each floor of a building. Accordingly, the platform coordination system 102 may create multiple sets of digital assets 155 each corresponding to one level (e.g., floor or other subdivision) of the building. The platform coordination system 102 (e.g., the service interface 124) may then repeat the minting process for each level of the building by associating the corresponding digital assets with a new NFT representing the digital assets on the blockchain. Such level NFTs may be stored at the owner wallet 152.

The platform coordination system 102 provides use of a level NFT in conjunction with lease of a portion of the building. As used herein, providing use of a level NFT may include renting, leasing, providing temporary use of in return for rent, but in some embodiments, transferring or conveying plans. In various examples, an owner may rent out the digital assets associated with a level NFT to, for example, a tenant of a floor of the building for the term of a lease. The platform coordination system 102 may record such a rental in several ways. In some examples, the platform coordination system 102 may update platform data 128 and/or services data 130 associated with the tenant user data to indicate that the tenant user has permission to view and/or utilize the digital assets represented by the relevant level NFTs. For example, services data 130 may be updated to give the tenant user access to the owner wallet 152 only for metadata associated with the location of the digital assets of the level NFT. The platform data 128 may be updated to associate the tenant user with the property associated with the level NFT. Accordingly, when the tenant user accesses the platform coordination system 102, portal configuration 126 may access the digital assets associated with the level NFT in the same manner as the user owner would, without providing the tenant user with access to the remainder of the owner user's wallet. In some examples, such permissions may be configured to expire automatically at the termination of the lease (e.g., at a date entered as the end of the lease). In some examples, the owner portal 158 may include options to indicate that the lease has been terminated, ending the tenant user's access to the level NFT.

In accordance with the above examples, building owners may retain ownership of digital assets of buildings through NFTs, while providing such assets to tenants for use during the lease term. Accordingly, owners may be able to derive monetary benefit from such NFTs and tenants may improve efficiencies in renovating, designing, and otherwise working on various properties. As the digital assets include models, floorplans, and other data reflecting the state of the building as-built (rather than plans showing how the building was intended to be built), such construction and design may be more efficient and accurate. For example, planned dimensions may be different than built dimensions, resulting in inaccuracies in ordering materials and completing work, which may cause delays. Using the platform coordination system described herein, tenants may utilize digital assets without creating the digital assets anew. Further, building owners may record ownership of such digital assets and use the assets in several ways, including to market spaces for rent within a building, offering the digital assets as an additional service to tenants during the term of a lease, utilizing the digital assets for maintenance, and the like. The use of NFTs, as well as the centralized nature of the platform coordination system with or without NFTs provides more secure and centralized storage for digital assets, meaning that owners and tenants are more likely to use the assets and less likely to have to repeat the process of digitization due to loss of the digital assets.

The technology described herein may be implemented as logical operations and/or modules in one or more systems. The logical operations may be implemented as a sequence of processor-implemented steps directed by software programs executing in one or more computer systems and as interconnected machine or circuit modules within one or more computer systems, or as a combination of both. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

In some implementations, articles of manufacture are provided as computer program products that cause the instantiation of operations on a computer system to implement the procedural operations. One implementation of a computer program product provides a non-transitory computer program storage medium readable by a computer system and encoding a computer program. It should further be understood that the described technology may be employed in special purpose devices independent of a personal computer.

The above specification, examples and data provide a complete description of the structure and use of exemplary embodiments of the invention as defined in the claims. Although various embodiments of the claimed invention have been described above with a certain degree of particularity, or with reference to one or more individual embodiments, it is appreciated that numerous alterations to the disclosed embodiments without departing from the spirit or scope of the claimed invention may be possible. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

1. A method comprising:
creating a primary non-fungible token (NFT), wherein the primary NFT represents digital assets associated with a physical building;
creating a plurality of level NFTs from the digital assets associated with the physical building, wherein each of the level NFTs represent digital assets associated with a sub-portion of the physical building; and
providing use of a level NFT of the plurality of level NFTs to a tenant in conjunction with lease of the sub-portion of the physical building represented by the level NFT.

2. The method of claim 1, wherein providing use of the level NFT comprises providing access to the digital assets associated with the sub-portion of the physical building represented by the level NFT for a period of time of a lease of the sub-portion of the physical building by the tenant.

3. The method of claim 1, wherein creating the primary NFT comprises utilizing an NFT marketplace to record the primary NFT on a blockchain and conferring ownership of the primary NFT to an owner of the physical building.

4. The method of claim 1, wherein creating the plurality of level NFTs comprises dividing the digital assets associated with the physical building into a plurality of level digital assets, wherein each of the plurality of level digital assets are associated with a respective sub-portion of the physical building.

5. The method of claim 4, wherein creating the plurality of level NFTs further comprises utilizing an NFT marketplace to record each of the plurality of level NFTs on a blockchain and conferring ownership of each of the plurality of level NFTs to an owner of the building.

6. The method of claim 5, wherein providing use of the level NFT of the plurality of level NFTs to the tenant comprises maintaining, by the owner of the building, ownership of the level NFT.

7. The method of claim 1, wherein the digital assets associated with the physical building include one or more of a building information model (BIM) of the physical building, a digital twin of the physical building, an engineering report for the physical building, and verified dimensions of the physical building.

8. The method of claim 1, further comprising viewing the digital assets associated with the physical building at a user portal associated with an owner of the physical building.

9. The method of claim 1, further comprising viewing digital assets associated with the sub-portion of the physical building at a user portal associated with the tenant.

10. A method comprising:
receiving, from a user, a request to access a user portal, wherein the user portal displays one or more digital assets representing one or more respective physical properties;
determining the one or more respective physical properties associated with the user;
retrieving the one or more digital assets representing the one or more respective physical properties; and
displaying, at the user portal, the one or more digital assets representing the one or more respective physical properties.

11. The method of claim 10, wherein displaying, at the user portal, the one or more digital assets corresponding to the one or more physical properties comprises displaying digital assets associated with a plurality of physical buildings owned by the user.

12. The method of claim 10, wherein displaying, at the user portal, the one or more digital assets corresponding to the one or more physical properties comprises displaying digital assets associated with a plurality of sub-portions of physical buildings leased by the user.

13. The method of claim 10, wherein the one or more digital assets comprise one or more of building information models (BIMs) of the one or more physical properties, digital twins of the one or more physical properties, engineering reports for the one or more physical properties, and verified dimensions of the one or more physical properties.

14. One or more non-transitory computer readable media encoded with instructions which, when executed by one or more processors of a platform coordination system, cause the platform coordination system to:
create a primary non-fungible token (NFT), wherein the primary NFT represents digital assets associated with a physical building;
create a plurality of level NFTs from the digital assets associated with the physical building, wherein each of the level NFTs represent digital assets associated with a sub-portion of the physical building; and
provide use of a level NFT of the plurality of level NFTs to a tenant in conjunction with lease of the sub-portion of the physical building represented by the level NFT.

15. The one or more non-transitory computer readable media of claim 14, wherein the instructions further cause the platform coordination system to provide use of the level NFT by providing access to the digital assets associated with the sub-portion of the physical building represented by the level NFT for a period of time of a lease of the sub-portion of the physical building by the tenant.

16. The one or more non-transitory computer readable media of claim 14, wherein the instructions further cause the platform coordination system to create the primary NFT by utilizing an NFT marketplace to record the primary NFT on a blockchain and conferring ownership of the primary NFT to an owner of the physical building.

17. The one or more non-transitory computer readable media of claim 14, wherein the instructions further cause the platform coordination system to create the plurality of level NFTs by dividing the digital assets associated with the physical building into a plurality of level digital assets, wherein each of the plurality of level digital assets are associated with a respective sub-portion of the physical building.

18. The one or more non-transitory computer readable media of claim 17, wherein the instructions further cause the platform coordination system to create the plurality of level NFTs by utilizing an NFT marketplace to record each of the plurality of level NFTs on a blockchain and conferring ownership of each of the plurality of level NFTs to an owner of the building.

19. The one or more non-transitory computer readable media of claim 14, wherein the digital assets associated with the physical building include one or more of a building information model (BIM) of the physical building, a digital twin of the physical building, an engineering report for the physical building, and verified dimensions of the physical building.

20. The one or more non-transitory computer readable media of claim 1, wherein the instructions further cause the platform coordination system to:
provide a first user portal associated with the owner of the physical building, wherein the first user portal allows the owner of the physical building to view the digital assets associated with the physical building; and
provide a second user portal associated with the tenant, wherein the second user portal allows the tenant to view the digital assets associated with the sub-portion of the physical building.
